(19) United States
(12) Patent Application Publication
(10) Pub. No.: US 2021/0252836 A1
(43) Pub. Date: Aug. 19, 2021

(54) WATER VAPOR PERMEABLE CROSS-LAMINATED POLYMER FILM ASSEMBLY

(71) Applicant: Illinois Tool Works Inc., Glenview, IL (US)

(72) Inventors: Michael Joseph Rancich, Houston, TX (US); Robert Lee Browning, Houston, TX (US)

(73) Assignee: Illinois Tool Works Inc., Glenview, IL (US)

(21) Appl. No.: 17/175,266

(22) Filed: Feb. 12, 2021

Related U.S. Application Data
(60) Provisional application No. 62/976,687, filed on Feb. 14, 2020.

(51) Int. Cl. B32B 27/08; C08K 3/26; B32B 7/12; B32B 27/32; B32B 27/20; B32B 37/12; B32B 38/00

(52) U.S. Cl. CPC B32B 27/08; C08K 3/26; B32B 7/12; B32B 27/32; B32B 27/20; B32B 2419/00; B32B 38/0004; C08K 2003/265; B32B 2307/724; B32B 2323/04; B32B 37/12

(57) ABSTRACT

A water vapor permeable polymer-based film assembly includes a first ply of a first water vapor permeable polymer having first polymer chains oriented in a first direction, a second ply of a second water vapor permeable polymer having second polymer chains oriented in a second direction that is transverse to the first direction, and an adhesive coupling the first ply of the first water vapor permeable polymer to the second ply of the second water vapor permeable polymer.

### CROSS-REFERENCE TO RELATED APPLICATIONS

This application claims priority to U.S. Provisional Application No. 62/976,687, which was filed on 14 Feb. 2020, and the entire disclosure of which is incorporated herein by reference.

### BACKGROUND

### Technical Field

The subject matter described herein relates to water vapor permeable films. Discussion of Art.

Water vapor permeable materials can be used in a variety of applications. For example, these materials may be used as air barriers that protect buildings (residential and/or commercial) during construction and throughout its life. These materials can permit water vapor to escape the building through the material but prevent ingress of liquid water into the building through the material.

Some known polymer-based water vapor permeable films easily tear during application or usage. This can provide openings through which liquid water can enter the building. The ingress of liquid water can cause mold and/or rot to set in the interior of the building.

Other water vapor permeable materials include nonwoven barriers that are more resistant to tears than other known polymer-based water vapor permeable films. But these nonwoven barriers tend to be significantly thicker and heavier than polymer-based films due to the need to entangle the fibers used to form the nonwoven barriers. The increased thickness of the nonwoven barriers makes these types of barriers stiffer and more difficult to adhere to certain surfaces, such as corners (e.g., inside corners) of buildings. The nonwoven barriers tend to release from these types of surfaces after a relatively short time period (e.g., one day). The increased weight of the nonwoven barriers also makes these barriers more likely to separate from the buildings. The separation of nonwoven barriers from the buildings can allow liquid water to enter the building.

### BRIEF DESCRIPTION

In one embodiment, a water vapor permeable polymer-based film assembly is provided. The assembly includes a first ply of a first water vapor permeable polymer having first polymer chains oriented in a first direction, a second ply of a second water vapor permeable polymer having second polymer chains oriented in a second direction that is transverse to the first direction, and an adhesive coupling the first ply of the first water vapor permeable polymer to the second ply of the second water vapor permeable polymer.

In one embodiment, a method is provided that includes cutting a first ply of a first water vapor permeable polymer such that first polymer chains in the first water vapor permeable polymer are oriented in a first direction, cutting a second ply of a second water vapor permeable polymer such that second polymer chains in the second water vapor permeable polymer are oriented in a second direction that is transverse to the first direction, and coupling the first ply of the first water vapor permeable polymer to the second ply of the second water vapor permeable polymer using an adhesive.

In one embodiment, a method includes cutting a first ply of a water vapor permeable polyethylene or polyolefin material having microvoids and a calcium carbonate additive. The first ply can be cut in a direction such that first polymer chains in the water vapor permeable polyethylene or polyolefin material in the first ply are oriented in a first direction. The method also includes cutting a second ply of the same water vapor permeable polyethylene or polyolefin material having the microvoids and the calcium carbonate additive. The second ply can be cut such that second polymer chains in the water vapor permeable polyethylene or polyolefin material in the second ply are oriented in a second direction that is transverse to the first direction. The method also includes coupling the first ply of the water vapor permeable polyethylene or polyolefin material to the second ply of the water vapor permeable polyethylene or polyolefin material using an adhesive such that a total thickness of the first ply, the adhesive, and the second ply is no greater than four mils.

### BRIEF DESCRIPTION OF THE DRAWINGS

The inventive subject matter may be understood from reading the following description of non-limiting embodiments, with reference to the attached drawings, wherein below:

FIG. 1 illustrates a cross-sectional view of one example of a water vapor permeable, cross-laminated polymer-based film assembly;

FIG. 2 schematically illustrates a plan view of the film assembly shown in FIG. 1; and

FIG. 3 illustrates a flowchart of one embodiment of a method for forming the water vapor permeable, cross-laminated polymer-based film assembly shown in FIGS. 1 and 2.

### DETAILED DESCRIPTION

One or more embodiments of the inventive subject matter described herein provide a water vapor permeable, cross-laminated polymer-based film assembly. The film assembly can be permeable to water vapor or, optionally, one or more other vapors. The film assembly may be used in mechanically attached or self adhered air barriers or for other uses where a film assembly is needed to prevent passage of liquid but permit passage of vapor through the film assembly. The film assembly can be formed from plies of polymer films having polymer chains oriented in different directions and made water vapor permeable by an additive. The plies (e.g., single polymer films) can be bias cut and laminated to each other using a permeable adhesive or polymer resin. Alternatively, the plies or films can be coupled to each other by co-extrusion of the films or in another manner. Each of the plies can have polymer chains primarily oriented in a designated direction. The plies can be coupled with each other such that the orientation of the polymer chains in one ply is different from the orientation of the polymer chains in another ply.

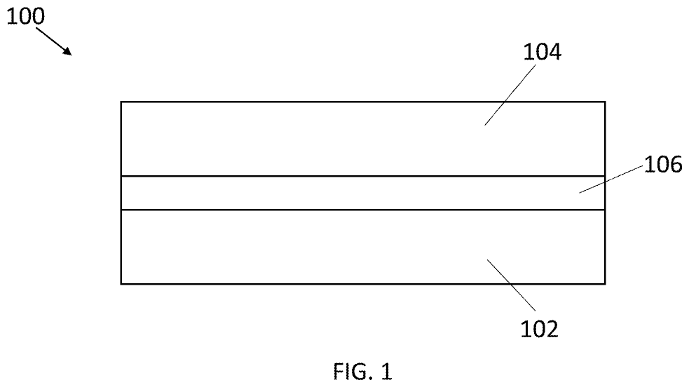

FIG. 1 illustrates a cross-sectional view of one example of a water vapor permeable, cross-laminated polymer-based film assembly 100. The film assembly 100 includes two plies 102, 104 of a polymer material. The plies 102, 104 may be formed of the same material. In one embodiment, the polymer material from which the plies 102, 104 are formed includes a polyethylene-based polymer. In another embodiment, this polymer material may be a polyolefin-based polymer. Alternatively, the plies 102, 104 may be formed from different materials. For example, the ply 102 may be formed from one polymer while the ply 104 is formed from another type of polymer. As another example, the plies 102, 104 may be formed from the same polymer, but may have different molecular weights. For example, the ply 102 may be formed from a polymer having a lower molecular weight than the ply 104.

The plies 102, 104 are not woven materials in one embodiment. For example, neither of the plies 102, 104 may be formed by entangling fibers of material. The plies 102, 104 can be layers having smooth surfaces that allow for better adhesion between the laminated film (100) at laps and seams when used in self-adhered air barriers.

The polymer materials that form the plies 102, 104 may include one or more additives that make the plies 102, 104 water vapor permeable. For example, the polymer materials may include a cavitation additive that creates micro voids in the polymer materials after orientation through which vapor, but not liquid, can pass through the plies 102, 104. One example of a cavitation additive is calcium carbonate, although another additive may be used in other examples. The additive may be included in the polymer materials used to form each of the plies 102, 104 in an amount that is less than the polymer material. For example, each of the plies 102, 104 may be formed from a greater amount of the polymer material (by weight) than the amount of additive. For example, the amount of additive should be sufficient to achieve a target permeability. In one embodiment, the additive is included within a range of ten to forty-five percent by weight.

The plies 102, 104 can be coupled to each other by an adhesive 106. This adhesive may be a water vapor permeable adhesive to permit vapor to pass through the assembly 100. Alternatively, the adhesive 106 can be a non permeable adhesive that is applied in a discontinuous way so as to provide locations where vapor can pass through. The adhesive 106 can be a pressure sensitive adhesive in one embodiment. The adhesive 106 can also be a water vapor permeable extrudable, polymeric material. Optionally, the adhesive 106 can be a urethane or acrylic-based material and can be solvent or water-borne. The adhesive 106 can be applied to the ply 102 through hot melt or gravure application methods. In one embodiment of the inventive subject matter described herein, the adhesive 106 is a solvent-borne, acrylic-based, pressure-sensitive adhesive that is applied by a hot melt method.

Each of the plies 102, 104 of film can be made by blown film extrusion followed by machine direction orientation followed by bias cutting. This blown film can be made as a single layer through mono-extrusion or as a multilayer through co-extrusion. The plies 102, 104 of the polymer films can then be adhered together using the adhesive 106.

The assembly 100 may be as thin as some known water vapor permeable materials used as air barriers, but may have increased tear strength relative to those known air barriers. For example, the assembly 100 may be no thicker than four mils (e.g., four thousandths of an inch), no thicker than six mils, or thinner than six and a half mils, or the like, but be more resistant to tear relative to other known air barriers.

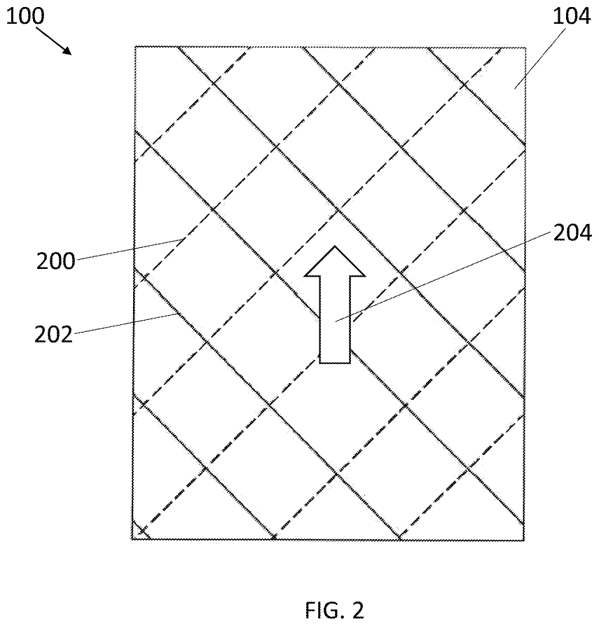

FIG. 2 schematically illustrates a plan view of the assembly 100 shown in FIG. 1. The ply 104 is visible in FIG. 2 but the ply 102 is not visible in FIG. 2. The plies 102, 104 may have elongated polymer chains that are oriented in different directions 200, 202. For example, the polymer chains forming the material in each of the plies 102, 104 may be primarily elongated along the respective directions 200, 202.

The assembly 100 may be formed in a machine direction 204. For example, the ply 102 may be unrolled along the machine direction 204 and cut in a transverse (e.g., perpendicular) direction to the machine direction 204, the adhesive 106 can be applied onto the ply 102, the ply 104 may be unrolled along the machine direction 204 and cut in the transverse direction, and the ply 104 can be adhered to the ply 102. As shown, the polymer chains are oriented in directions 200, 202 that are not parallel to the machine direction 204. For example, the directions 200, 202 in which the polymer chains are oriented can be transverse to the machine direction 204. In the illustrated example, the polymer chains are oriented in directions 200, 202 that are between perpendicular and parallel to the machine direction 204, such as angles of thirty to sixty degrees, angles of at forty-five degrees, or the like, to the machine direction 204.

As shown in FIG. 2, the directions 200, 202 in which the polymer chains are oriented in the different plies 102, 104 are transverse to each other. In one embodiment, the directions 200, 202 are perpendicular to each other. Alternatively, the directions 200, 202 may be oriented in other directions to each other, such as at fifteen degrees, thirty degrees, forty-five degrees, sixty degrees, seventy degrees, or the like. Orienting the polymer chains in the plies 102, 104 in different directions can increase the strength of the film assembly 100 without requiring the film assembly 100 to be heavy, thick, or stiff. For example, the film assembly 100 may be as thin or thinner than some known polymer-based water vapor permeable films used as air barriers, but more resistant to tearing forces than these known polymer-based water vapor permeable films. Additionally, the film assembly 100 may be as resistant to tearing forces as some known woven water vapor permeable assemblies used as air barriers, but lighter than these woven water vapor permeable assemblies.

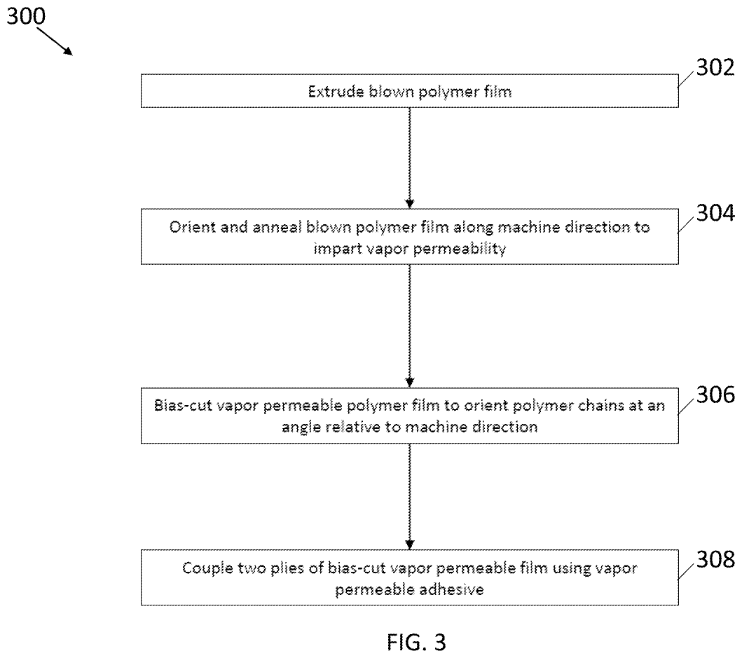

FIG. 3 illustrates a flowchart of one embodiment of a method 300 for forming the water vapor permeable, cross-laminated polymer-based film assembly 100 shown in FIGS. 1 and 2. At 302, a blown polymer film is formed using a blown film process. At 304, this blown polymer film is oriented and annealed along a machine direction. For example, the polymer chains in the blown polymer film can be oriented in a direction (e.g., the direction 204) and then the polymer film is annealed. The orienting and annealing of the blown polymer film provides vapor permeability to the film. At 306, this water vapor permeable polymer film is bias-cut to orient the polymer chains in the water vapor permeable polymer film at a desired angle to the machine direction. For example, the bias-cutting of the water vapor permeable polymer film can orient the polymer chains so that the direction 200 or 202 of the polymer chains is transverse (e.g., not parallel) to the machine direction. The operations of 302, 304, 306 can be repeated so that two water vapor permeable polymer films are created. At 308, the two water vapor permeable polymer films or plies are coupled using a water vapor permeable adhesive. The films or plies can be adhered to each other with the polymer chains in the films oriented in different directions to each other and to the machine direction.

In one embodiment, a water vapor permeable polymer-based film assembly is provided. The assembly includes a first ply of a first water vapor permeable polymer having first polymer chains oriented in a first direction, a second ply of a second water vapor permeable polymer having second polymer chains oriented in a second direction that is transverse to the first direction, and an adhesive coupling the first ply of the first water vapor permeable polymer to the second ply of the second water vapor permeable polymer.

Optionally, the first water vapor permeable polymer and the second water vapor permeable polymer are formed from the same polymer material.

Optionally, the first water vapor permeable polymer and the second water vapor permeable polymer are formed from different polymer materials.

Optionally, the first water vapor permeable polymer and the second water vapor permeable polymer are formed from a polyethylene material.

Optionally, the first water vapor permeable polymer and the second water vapor permeable polymer are formed from a polyolefin material.

Optionally, the first water vapor permeable polymer and the second water vapor permeable polymer include microvoids. A microvoid can be an enclosed volume within the polymers that is small. The volume can be enclosed in that the polymer material completely surrounds the volume that is the microvoid. In one embodiment, the microvoid is no larger than 200 nanometers in any direction. In another embodiment, the microvoid is no larger than 20 nanometers in any direction. In another embodiment, the microvoid is no larger than 2 nanometers in any direction. In another embodiment, the microvoid is no larger than 500 nanometers in any direction. Alternatively, the microvoid may be larger.

Optionally, the first water vapor permeable polymer and the second water vapor permeable polymer include a cavitation additive.

Optionally, the first water vapor permeable polymer and the second water vapor permeable polymer include a calcium carbonate additive.

Optionally, the first direction in which the first polymer chains are oriented in the first ply is perpendicular to the second direction in which the second polymer chains are oriented.

Optionally, the first direction in which the first polymer chains are oriented in the first ply is not perpendicular to the second direction in which the second polymer chains are oriented.

Optionally, a total thickness of the first ply, the adhesive, and the second ply is no greater than four mils.

Optionally, a total thickness of the first ply, the adhesive, and the second ply is smaller than six and half mils.

Optionally, the adhesive is a pressure-sensitive adhesive.

In one embodiment, a method is provided that includes cutting a first ply of a first water vapor permeable polymer such that first polymer chains in the first water vapor permeable polymer are oriented in a first direction, cutting a second ply of a second water vapor permeable polymer such that second polymer chains in the second water vapor permeable polymer are oriented in a second direction that is transverse to the first direction, and coupling the first ply of the first water vapor permeable polymer to the second ply of the second water vapor permeable polymer using an adhesive.

Optionally, the first water vapor permeable polymer and the second water vapor permeable polymer are formed from the same polymer material.

Optionally, the first water vapor permeable polymer and the second water vapor permeable polymer are formed from different polymer materials.

Optionally, the first water vapor permeable polymer and the second water vapor permeable polymer are formed from a polyethylene material.

Optionally, the first water vapor permeable polymer and the second water vapor permeable polymer are formed from a polyolefin material.

Optionally, the first water vapor permeable polymer and the second water vapor permeable polymer include microvoids.

Optionally, the first water vapor permeable polymer and the second water vapor permeable polymer include a cavitation additive.

Optionally, the first water vapor permeable polymer and the second water vapor permeable polymer include a calcium carbonate additive.

Optionally, the first ply and the second ply are cut such that the first direction in which the first polymer chains are oriented in the first ply is perpendicular to the second direction in which the second polymer chains are oriented.

Optionally, the first ply and the second ply are cut such that the first direction in which the first polymer chains are oriented in the first ply is not perpendicular to the second direction in which the second polymer chains are oriented.

Optionally, the first ply and the second ply are coupled with each other such that a total thickness of the first ply, the adhesive, and the second ply is no greater than four mils.

Optionally, the first ply and the second ply are coupled with each other such that a total thickness of the first ply, the adhesive, and the second ply is smaller than six and half mils.

In one embodiment, a method includes cutting a first ply of a water vapor permeable polyethylene or polyolefin material having microvoids and a calcium carbonate additive. The first ply can be cut in a direction such that first polymer chains in the water vapor permeable polyethylene or polyolefin material in the first ply are oriented in a first direction. The method also includes cutting a second ply of the same water vapor permeable polyethylene or polyolefin material having the microvoids and the calcium carbonate additive. The second ply can be cut such that second polymer chains in the water vapor permeable polyethylene or polyolefin material in the second ply are oriented in a second direction that is transverse to the first direction. The method also includes coupling the first ply of the water vapor permeable polyethylene or polyolefin material to the second ply of the water vapor permeable polyethylene or polyolefin material using an adhesive such that a total thickness of the first ply, the adhesive, and the second ply is no greater than four mils.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A water vapor permeable polymer-based film assembly comprising:
a first ply of a first water vapor permeable polymer having first polymer chains oriented in a first direction;
a second ply of a second water vapor permeable polymer having second polymer chains oriented in a second direction that is transverse to the first direction; and
an adhesive coupling the first ply of the first water vapor permeable polymer to the second ply of the second water vapor permeable polymer.

2. The film assembly of claim 1, wherein the first water vapor permeable polymer and the second water vapor permeable polymer are formed from the same polymer material.

3. The film assembly of claim 1, wherein the first water vapor permeable polymer and the second water vapor permeable polymer are formed from different polymer materials.

4. The film assembly of claim 1, wherein the first water vapor permeable polymer and the second water vapor permeable polymer are formed from a polyethylene material.

5. The film assembly of claim 1, wherein the first water vapor permeable polymer and the second water vapor permeable polymer are formed from a polyolefin material.

6. The film assembly of claim 1, wherein the first water vapor permeable polymer and the second water vapor permeable polymer include microvoids.

7. The film assembly of claim 1, wherein the first water vapor permeable polymer and the second water vapor permeable polymer include a cavitation additive.

8. The film assembly of claim 1, wherein the first water vapor permeable polymer and the second water vapor permeable polymer include a calcium carbonate additive.

9. The film assembly of claim 1, wherein the first direction in which the first polymer chains are oriented in the first ply is perpendicular to the second direction in which the second polymer chains are oriented.

10. The film assembly of claim 1, wherein the first direction in which the first polymer chains are oriented in the first ply is not perpendicular to the second direction in which the second polymer chains are oriented.

11. The film assembly of claim 1, wherein a total thickness of the first ply, the adhesive, and the second ply is no greater than four mils.

12. The film assembly of claim 1, wherein a total thickness of the first ply, the adhesive, and the second ply is smaller than six and half mils.

13. The film assembly of claim 1, wherein the adhesive is a pressure-sensitive adhesive.

14. A method comprising:
cutting a first ply of a first water vapor permeable polymer such that first polymer chains in the first water vapor permeable polymer are oriented in a first direction;
cutting a second ply of a second water vapor permeable polymer such that second polymer chains in the second water vapor permeable polymer are oriented in a second direction that is transverse to the first direction; and
coupling the first ply of the first water vapor permeable polymer to the second ply of the second water vapor permeable polymer using an adhesive.

15. The method of claim 14, wherein the first water vapor permeable polymer and the second water vapor permeable polymer are formed from the same polymer material.

16. The method of claim 14, wherein the first water vapor permeable polymer and the second water vapor permeable polymer are formed from different polymer materials.

17. The method of claim 14, wherein the first water vapor permeable polymer and the second water vapor permeable polymer are formed from a polyethylene material.

18. The method of claim 14, wherein the first water vapor permeable polymer and the second water vapor permeable polymer are formed from a polyolefin material.

19. The method of claim 14, wherein the first water vapor permeable polymer and the second water vapor permeable polymer include microvoids.

20. A method comprising:
cutting a first ply of a water vapor permeable polyethylene or polyolefin material having microvoids and a calcium carbonate additive, the first ply cut in a direction such that first polymer chains in the water vapor permeable polyethylene or polyolefin material in the first ply are oriented in a first direction;
cutting a second ply of the water vapor permeable polyethylene or polyolefin material having the microvoids and the calcium carbonate additive, the second ply cut such that second polymer chains in the water vapor permeable polyethylene or polyolefin material in the second ply are oriented in a second direction that is transverse to the first direction; and
coupling the first ply of the water vapor permeable polyethylene or polyolefin material to the second ply of the water vapor permeable polyethylene or polyolefin material using an adhesive such that a total thickness of the first ply, the adhesive, and the second ply is no greater than four mils.
